(19) United States
(12) Patent Application Publication
(10) Pub. No.: US 2013/0339849 A1
(43) Pub. Date: Dec. 19, 2013

(54) DIGITAL CONTENT PREPARATION AND PRESENTATION

(71) Applicant: Amr Mohamed Mebed, Giza (EG)

(72) Inventor: Amr Mohamed Mebed, Giza (EG)

(73) Assignee: MICROSOFT CORPORATION, Redmond, WA (US)

(21) Appl. No.: 13/527,452

(22) Filed: Jun. 19, 2012

(51) Int. Cl. G06F 17/00

(52) U.S. Cl. 715/273

(57) ABSTRACT

Embodiments are disclosed herein that relate to customizing a presentation of digital content to a user based upon a representation of a personality type of the user. For example, one disclosed embodiment provides a computing system configured to receive digital content for presentation to a user, and to compare one or more personality type labels associated with the digital content to a personality type indicator of the user. The computing system is further configured to customize presentation of the digital content based on a result of comparing the personality type indicator of the user with the one or more personality type labels. Embodiments are also disclosed that relate to detecting an emotional state of a user during a user input of digital content, and associating a representation of the detected emotional state with the digital content.

### BACKGROUND

Computing devices may be used to prepare and present digital content of many different types. For example, computing devices may be used to prepare and present emails, web pages, and other such text- and/or hypertext-based content. Further, users may create or otherwise input such digital content in different ways, including but not limited to via keyboards and voice recognition methods.

Computing devices receiving digital content may be configured to present the digital content in ways that are customized based upon user preferences. For example, users may elect to have text content presented in selected fonts, styles, etc. Further, other user preferences may be applied. For example, email messages or web pages may be automatically translated based upon a preferred presentation language specified by a recipient user. As such, a group message sent to more than one recipient, or a web page accessed by multiple recipients, may be presented differently for different recipients.

### SUMMARY

Embodiments are disclosed herein that relate to customizing a presentation of digital content to a user based upon a representation of a personality type of the user. For example, one disclosed embodiment provides a computing system configured to receive a digital content item for presentation to a user, and to compare one or more personality type labels associated with the digital content item to a personality type indicator of the user. The computing system is further configured to customize presentation of the digital content based on a result of comparing the personality type indicator of the user with the one or more personality type labels associated with one or more portions of the digital content item. Embodiments are also disclosed that relate to detecting an emotional state of a user during a user input of digital content, and associating a representation of the detected emotional state with the digital content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 schematically shows an embodiment of a use environment for the presentation of customized content based upon personality type information.

FIG. 2 is a flow chart depicting an embodiment of a method for preparing a digital content item for customized presentation based upon personality type labels.

FIG. 3 is a flow chart depicting an embodiment of a method of customizing a presentation of digital content based on comparing a personality type indicator with one or more personality type labels.

FIG. 4 shows an embodiment of a digital content item.

FIG. 5 shows a first portion of the digital content item of FIG. 4 tagged with an embodiment of a first personality type label.

FIG. 6 shows a second portion of the digital content item of FIG. 4 tagged with an embodiment of a second personality type label.

FIG. 7 shows an embodiment of a presentation of the digital content item of FIG. 4 based upon a first personality type indicator.

FIG. 8 shows an embodiment of a presentation of the digital content item of FIG. 4 based upon a second personality type indicator.

FIG. 9 is a flow chart depicting an embodiment of a method of sending a representation of an emotional state to a receiving device based upon detecting a user input and associating an emotional state with a user input device.

FIG. 10 depicts an embodiment of a computing device receiving a user audio input while monitoring the user for emotional state information.

FIG. 11 depicts an embodiment of a representation of a detected emotional state associated with the user input of FIG. 10.

FIG. 12 schematically shows an embodiment of a computing system.

### DETAILED DESCRIPTION

As mentioned above, a message sent to more than one recipient, or a web page accessed by multiple recipients, may be presented differently for different recipients. For example, users may elect to have text in an email presented in a certain type of font. In another example, programs may automatically translate web pages into a language of a user's choice. However, in each of these examples, the same content is presented to each user, albeit with different appearances. Depending upon the personality type of recipients of a digital content item, some recipients may wish to view certain portions of the digital content item, while others may be interested in viewing the entire digital content item.

Therefore, embodiments are disclosed herein that relate to customizing a presentation of digital content based on a representation of a user's personality. Briefly, the disclosed embodiments compare a personality type indicator of the user with one or more personality type labels contained within the digital content, and present portions of the digital content item based on a result of comparing the personality type indicator of the user with the personality type labels. While some examples described below are presented in the context of color-based personality type indicators and personality type labels, it will be understood that any suitable representation of personality types may be used as indicators and labels.

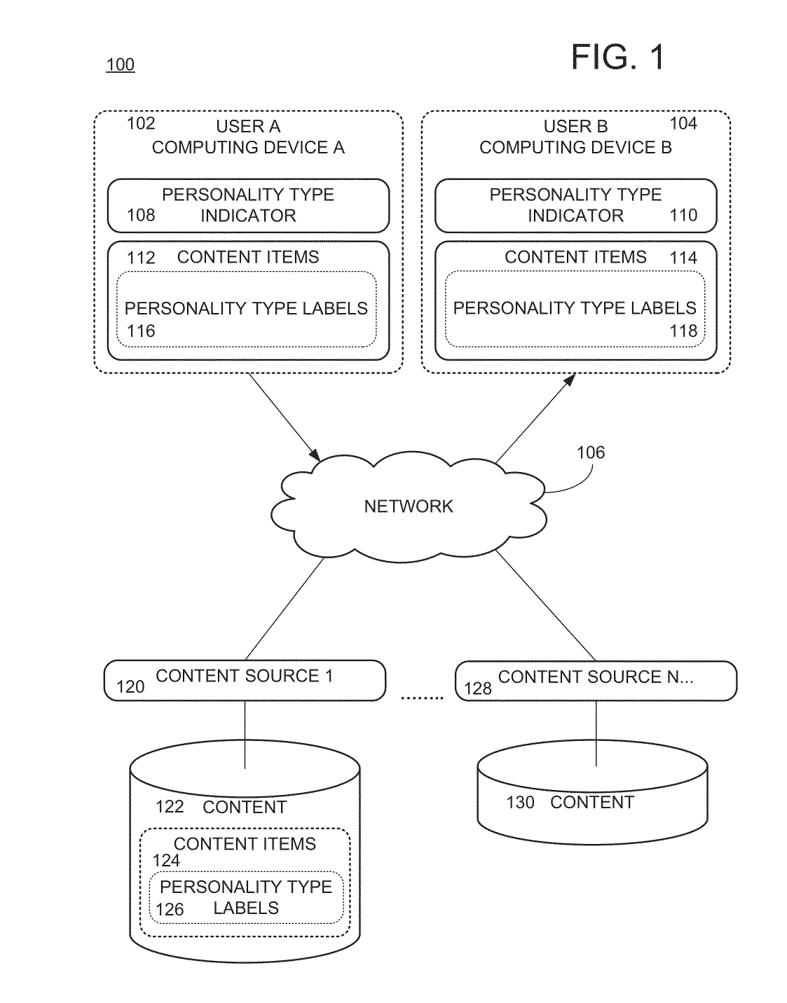

FIG. 1 shows an example embodiment of a use environment 100 for the authoring and/or customized presentation of digital content comprising personality type labels. Use environment 100 illustrates computing device A 102 associated with a user A and computing device B 104 associated with a user B connected through a network 106. It will be understood that FIG. 1 depicts two computing devices for the purpose of clarity, and that use environment 100 may include any suitable number of computing devices connected via any suitable network or combination of networks, including but not limited to local area and/or wide area computer networks such as the Internet and other computer networks, cellular telephone networks, etc.

Computing device A 102 and computing device B 104 each includes a personality type indicator, shown respectively at 108 and 110, stored in memory. The personality type indicators 108 and 110 comprise a representation of a personality type, trait, characteristic, etc. of the user associated with that computing device. The personality type indicators 108 and 110 may have any suitable form. Examples of suitable representations include, but are not limited to, color-based representations (e.g. where particular colors are associated with particular personality traits) and alphanumeric code-based representations (e.g. Meyers-Briggs labels).

A personality type indicator for a user may be determined in any suitable manner. For example, in some embodiments, the personality type indicator 108 may be established through a personality assessment performed by the user via computing device. In other embodiments, a user may select a personality type indicator from a list of personality type indicators, for example, based upon a description of the personality type indicators provided to the user. In yet another example, the personality type indicator 108 may be established at least in part from user behavior data collected via sensing devices. It will be understood that these embodiments are described for the purpose of example, and are not intended to be limiting in any manner.

As mentioned above, computing device A 102 and computing device B 104 may use the personality type indictors to customize the presentation of digital content. FIG. 1 shows examples of such content as digital content items 112 and 114 respectively on computing device A 102 and computing device B 104. The illustrated digital content items 112 and 114 may represent any suitable type of digital content items. Examples may include, but are not limited to, web pages, emails, text messages and other types of documents, and any other suitable digital content.

As mentioned above, portions of the digital content items 112 and 114 may be tagged with one or more personality type labels 116 and 118 contained within or otherwise associated with the content items 112 and 114, respectively. The personality type labels indicate portions of a content item to be presented or not presented based upon the personality type indicator applied to the content item at presentation. As a more specific example, in some embodiments, content tagged with a personality type label that matches the personality type indicator on the presenting computing device is presented, while content that is not tagged with the matching personality type label is not presented. In other embodiments, a different scheme may be used, such that tagging the content with a personality type label results in the content not being presented. It will be understood that these examples of the interpretation of personality type labels by a presenting device are described for the purpose of example, and are not intended to be limiting in any manner.

Personality type labels may be added to a content item during authoring of the content item, or at a later time. For example, a person preparing an email message may have the option of tagging the email message with personality type labels. Such tagging may be applied to specific content selected by the user, to one or more sections of a predefined document template, or in any other suitable manner.

In some embodiments, personality type labels also may be contained within content accessible via remote content services, such as web sites, FTP (File Transfer Protocol) sites, and the like. FIG. 1 illustrates example an arbitrary number of remote content sources as content source 1 120 and content source N 128 respectively comprising content 122 and content 130. Content 122 and 130 each may comprise one or more content items 124 having personality type labels, illustrated at 126 for content 122, thereby allowing the customized presentation of the content items as described above. Content 122, 130 may comprise any suitable types of content items, including but not limited to documents such as web pages, text files and other documents, as well as audio files, video files, image files, etc.

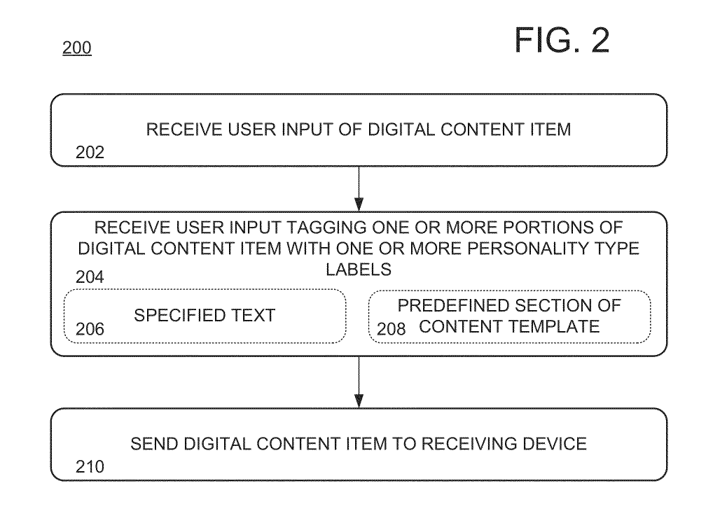

FIG. 2 shows a flow diagram depicting an embodiment of a method 200 for preparing a digital content item for customized presentation based upon personality type information. Method 200 comprises, at 202, receiving a user input of a digital content item. As mentioned above, digital content items may include, but are not limited to, web pages, email messages, text messages, and/or any other suitable type of digital content.

Next, method 200 comprises, at 204, receiving a user input associating one or more portions of the digital content item with one or more personality type labels. The user may associate the personality type labels with the portions of the digital content item in any suitable manner. For example, as indicated at 206, the user may associate a selected portion of a digital content item with a personality type label by selecting specified text in a digital content item (e.g. with a cursor, via a touch input, etc.), and then applying a desired label to the specified text. In other embodiments, a user may apply a personality type label to a document by labeling a predefined section of a content template. It will be understood that these examples of methods of associating portions of the digital content item with personality type labels are described for the purpose of example and are not intended to be limiting in any manner. After receiving the user input tagging the one or more portions of the digital content item with the personality type label, method 200 comprises, at 210, sending the digital content item to one or more receiving devices.

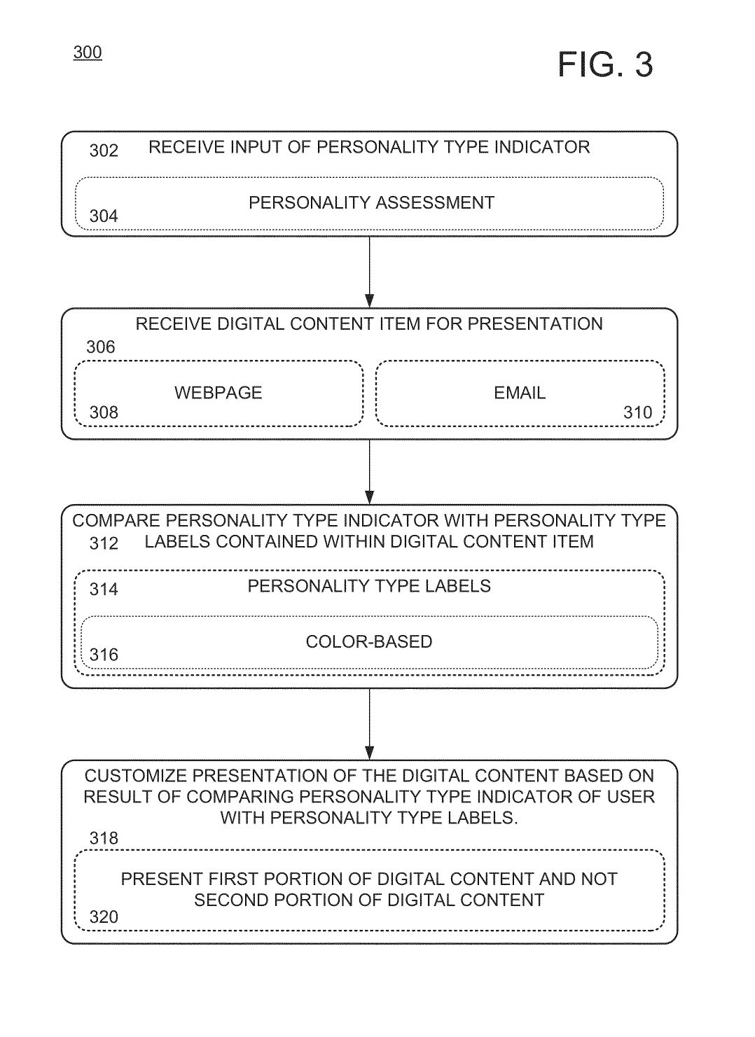

FIG. 3 shows a flow diagram depicting an embodiment of a method 300 for customizing the presentation of digital content based on a result of comparing a personality type indicator with the one or more personality type labels. Method 300 comprises, at 302, receiving an input of a personality type indicator for a user of a computing device. The personality type indicator may be received in any suitable manner. For example, in some embodiments, a user may take a personality assessment 304 that assigns the personality type based upon answers to questions in the assessment. As another example, the user may select the personality type indicator from a menu of personality types. As yet another example, the personality type indicator may be established at least in part from user behavior data collected via external sensing devices, such as a depth camera connected to a computing device, that may be used to detect the user's emotional states over time.

Method 300 next comprises, at 306, receiving a digital content item for presentation to a user, wherein the digital content item comprises associated personality type labels. Examples of such digital content items may include, but are not limited to, documents such as web pages 308 and email messages 310. The personality type labels may be incorporated into the content item, appended to the content item, stored separately from the content but linked with the content item, or associated with the content item in any other suitable manner.

Method 300 further comprises, at 312, comparing the personality type indicator of the user with the one or more personality type labels 314 associated with the digital content. As mentioned above, the personality type indicator comprises a representation of a personality type, trait, characteristic, etc. of the user associated with that computing device, and may take any suitable form. FIG. 3 shows one example of a suitable representation in the form of a color-based representation 316, but it will be understood that any other suitable representation may be used.

Continuing, method 300 comprises, at 318, customizing a presentation of the digital content based on a result of comparing the personality type indicator of the user with the one or more personality type labels. As illustrated at 320, this may comprise presenting a first portion of the digital content while not presenting a second portion of the digital content based upon whether a personality type label associated with a portion matches the personality type indicator of the user. Customizing also may comprise presenting different portions of the content item with different appearances based upon the result of comparing the personality type indicator with the personality type labels (e.g. to emphasize or deemphasize portions based upon the personality type labels, to reorder portions, etc.), and/or any other suitable way of distinguishing different portions of a content item based upon personality type labels associated with the portions of the content item.

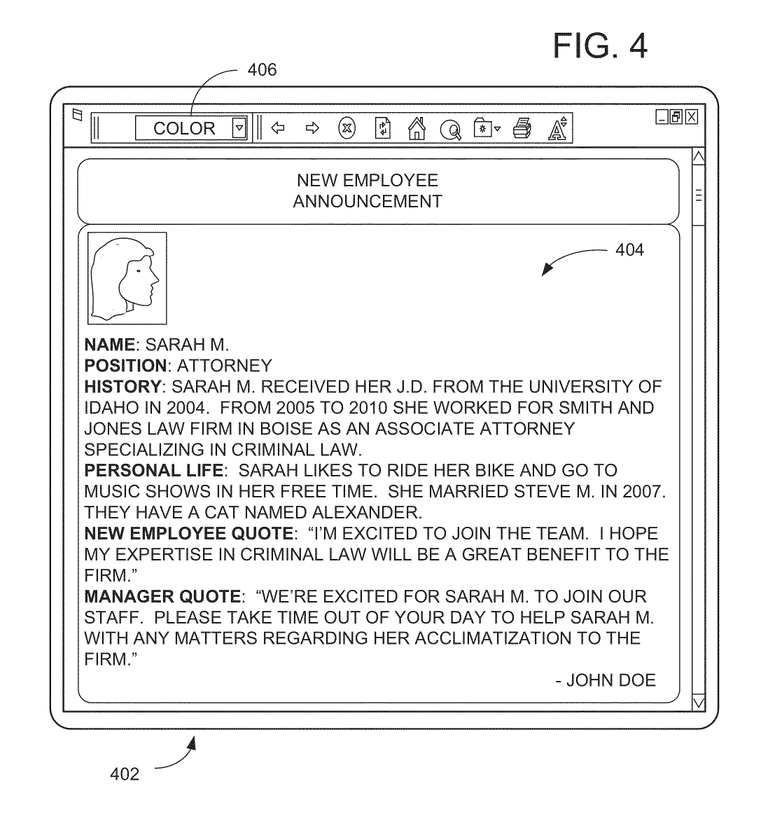

FIGS. 4, 5, 6 and 7 together illustrate an example of the preparation and presentation of an embodiment of a digital content item comprising personality type labels associated with portions of the content item. First, FIG. 4 shows an embodiment of a digital content item in the form of an email message 402 announcing a new employee. The email message 402 includes information 404 regarding the new employee, such as a portrait, name, position, history, and other such information regarding the new employee. The top left portion of the authoring software user interface used to prepare the email message 402 includes a drop-down menu 406 for tagging portions of the email message 402 with a color-based personality type label. In other embodiments, the authoring software may comprise document preparation templates that allow a user to tag pre-defined sections of the body of the email message. It will be understood that these embodiment are presented for purposes of example, and are not intended to be limiting in any manner.

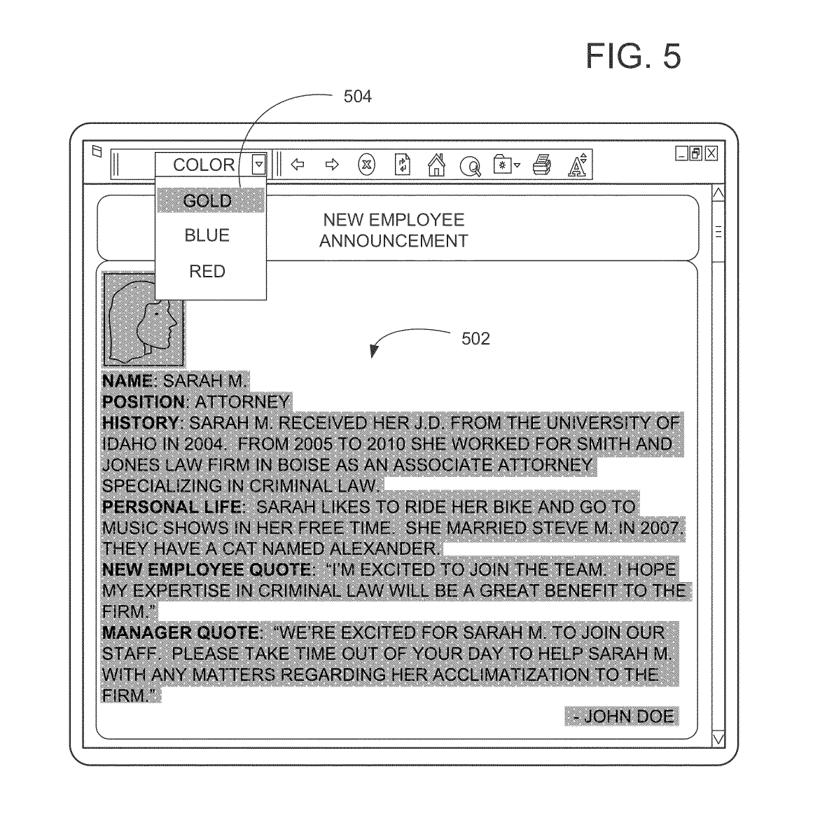

Next, FIG. 5 illustrates the addition of a first personality type label to a first portion 502 of the email message of FIG. 4, shown as comprising the entire text of the email message. As illustrated, the first personality type label 504 denotes a “gold” personality type label, and is selected from the drop-down menu of FIG. 4. In this example, the gold personality type may signify a personality type that is likely to wish to view all of the details in the new employee email.

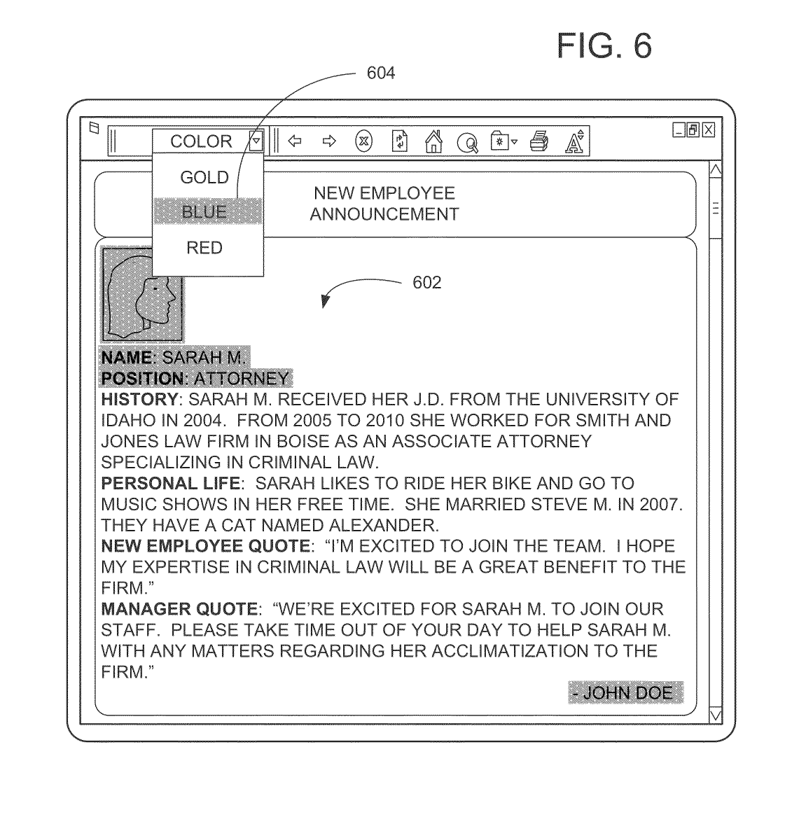

FIG. 6 illustrates the addition of a second personality type label to the email message of FIG. 4. More specifically, FIG. 6 shows the email message 402 of FIG. 4 with a second portion 602 specified by highlighting for associating with a second personality type label 604 that denotes a “blue” personality type. In this example, the second personality type label 604 may correspond to an employee who is likely to wish to read key information, rather than all details, in the email message. It will be understood that the first and second portions may have any suitable relationship to one another. For example, the first and second portion may or may not be overlapping, and that one portion may wholly contain another portion, as depicted in FIGS. 4 and 5. Further, while illustrated herein as two personality type labels applied to two content portions, it will be understood that any suitable number of labels may be applied to any suitable number of portions of a digital content item.

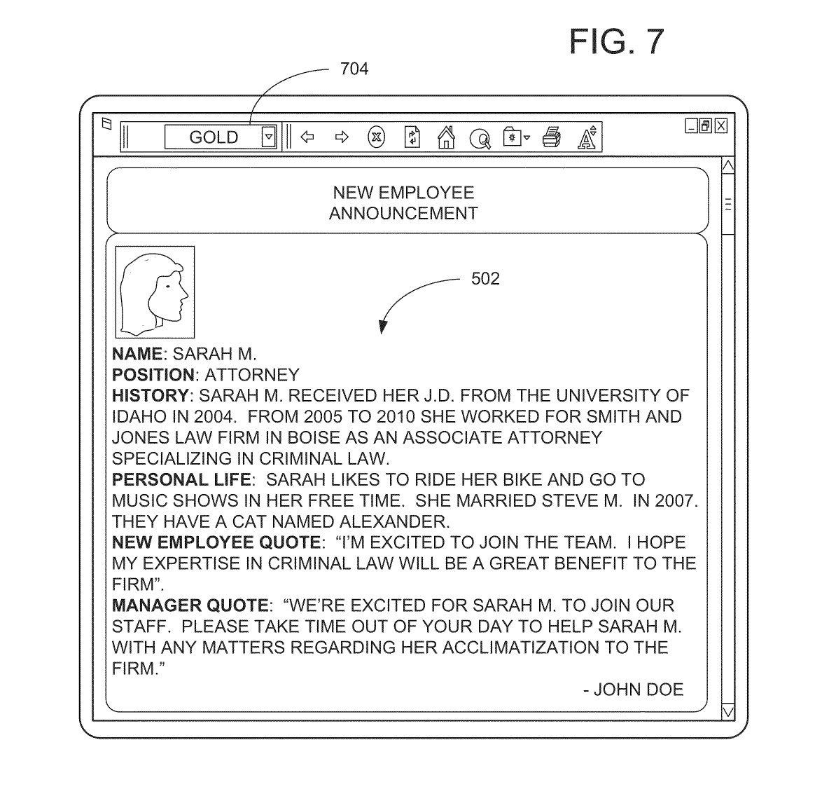

FIG. 7 illustrates one example of the customized presentation of the email message 402 by a recipient computing device. As illustrated, the recipient computing device comprises a “gold” personality type indicator 704. As a result of comparing the personality type labels contained within the email with the personality type indicator 704 on the receiving device, the user on the receiving device is presented with the first portion 502 of the content of the email tagged with the first personality type label 504 (e.g. the “gold” personality type label).

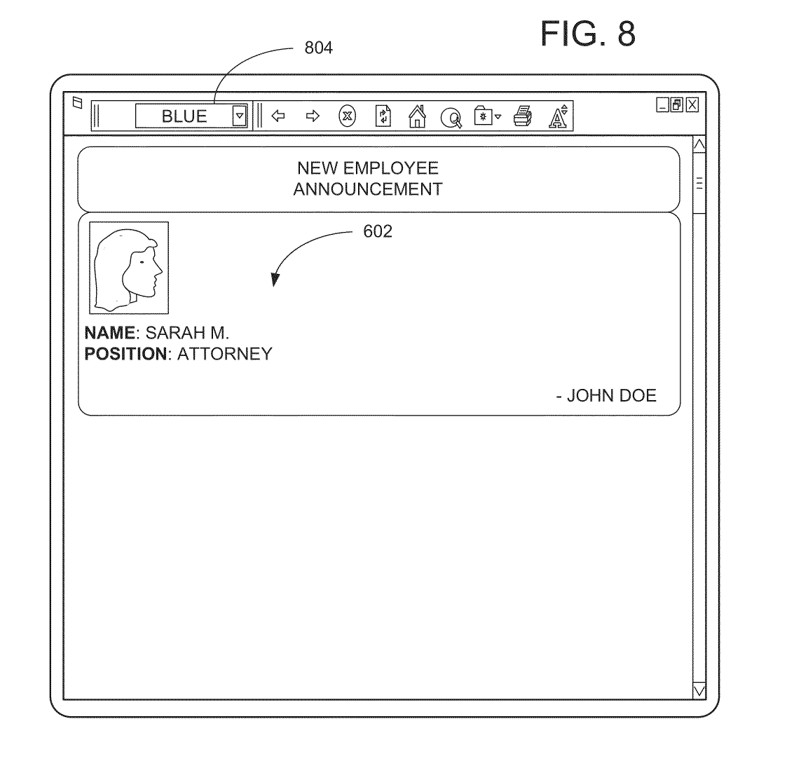

FIG. 8 illustrates another example of the customized presentation of the email message 402 by a recipient computing device. As illustrated, the recipient computing device comprises a “blue” personality type indicator 804. As a result of comparing the personality type labels contained within the email with the personality type indicator 804 on the receiving device, the user on the receiving device is presented with the second portion 602 of the email message associated with the blue color-based personality type label by the user on the sending device in FIG. 6. Other portions of the email remain hidden.

When preparing digital messages or other digital content items, an author of the content item may perform various expressions of an emotional state. For example, the content item author may smile, frown, laugh, press a keyboard or touch screen forcefully, perform a gesture-based touch input at a rapid pace, etc. However, unless the user incorporates a description of such emotional states into the content of the message, for example, via the appearance of the text, emoticon, or other such representation of the emotional state, the emotional state will not be communicated to the recipient as well as if the communication were performed face-to-face.

Therefore, embodiments are disclosed herein that relate to sensing an emotional state of a user during the preparation of a digital content item via sensor devices, and automatically associating a representation of the emotional state with a portion of the digital content item. Various sensors, such as image sensors, touch sensors (including but not limited to multi-touch sensors), pressure sensors, microphones, etc. are increasingly incorporated into computing devices as standard hardware. Data received from such sensors may be analyzed, for example using a classification function trained via a training set of data linking emotional states to sensor inputs, to determine a possible emotional state of the user, and to associate a representation of the emotional state with a portion of the content item being authored when the emotional state was expressed.

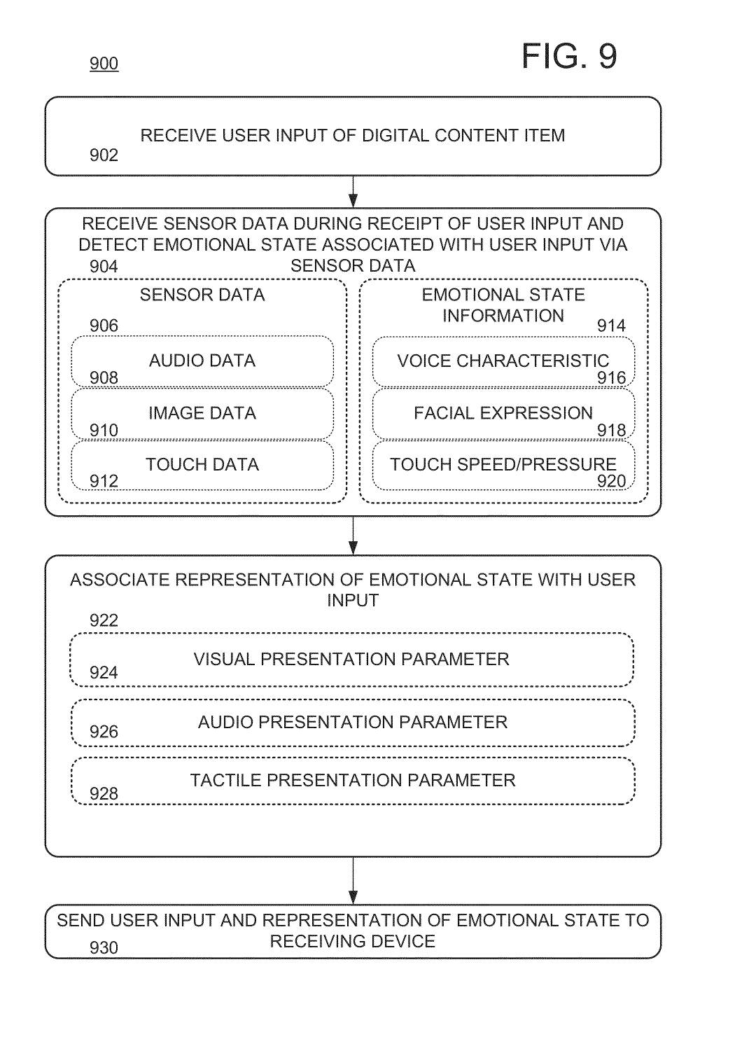

FIG. 9 shows a flow diagram illustrating an embodiment of a method 900 of detecting an emotional state of a user while the user inputs a digital content item via data from one or more sensors, and associating a representation of an emotional state with a portion of the digital content item. Method 900 comprises at 902, receiving a user input of the digital content item. The input may comprise text input (e.g. entered by keyboard or virtual keyboard for an email message or other electronic message), voice input (e.g. for conversion to text via a voice recognition program), and/or any other suitable type of input. Further, the input may comprise an initial authoring of the digital content item, an input of a previously prepared or received digital content item for editing, etc.

Next, method 900 comprises, at 904, receiving sensor data during receipt of the user input, and detecting an emotional state associated with the user input via the sensor data received during receipt of the user input. The sensor data 906 may include any suitable data from which emotional state information may be determined. Examples include, but are not limited to, audio data 908, image data 910, and touch data 912 (which may include pressure and/or gesture data). Other types of sensor input, such as motion data from an intertial motion sensor, also may be received.

The emotional state information detected via such data may include, but is not limited to, a touch speed/pressure 920 (including gesture speed), a voice characteristic 916, a facial expression 918 (including facial gestures) or other body language detected via the image sensor, and/or any other suitable information. In a non-limiting example, a user may prepare an email message on a computing device that comprises, or otherwise receives data from, a depth camera capturing the user's face. In this instance, facial data from the depth camera may be classified to detect emotional states in the facial data.

Next, method 900 comprises, at 922, associating a representation of the emotional state with a portion of the user input that corresponds temporally and/or contextually with the detected emotional state. Any suitable representation of a detected emotional state may be used, including but not limited to representations related to visual presentation parameters 924, audio presentation parameters 926, and/or tactile presentation parameters 928. For example, where a user's detected emotional state is happy, text may be marked for presentation in a color that represents happiness (e.g. yellow). Likewise, a simulated voice output of this text may be processed to modify an inflection, volume, and/or other characteristic of the output. Further, a haptic feedback mechanism, such as a vibration mechanism, may be actuated to emphasize an emotional state. After associating the representation of the emotional state with the user input, method 900 comprises, at 930, sending the input and the representation of the emotional state to a receiving device. It will be understood that any suitable visual, audio, and/or tactile presentation parameter may be adjusted. Examples of suitable visual presentation parameters include, but are not limited to, style, format, color, size, emphasis, animation, and accenting. Examples of suitable audio presentation parameters include, but are not limited to, pitch, volume, intonation, duration, prosody, and rate.

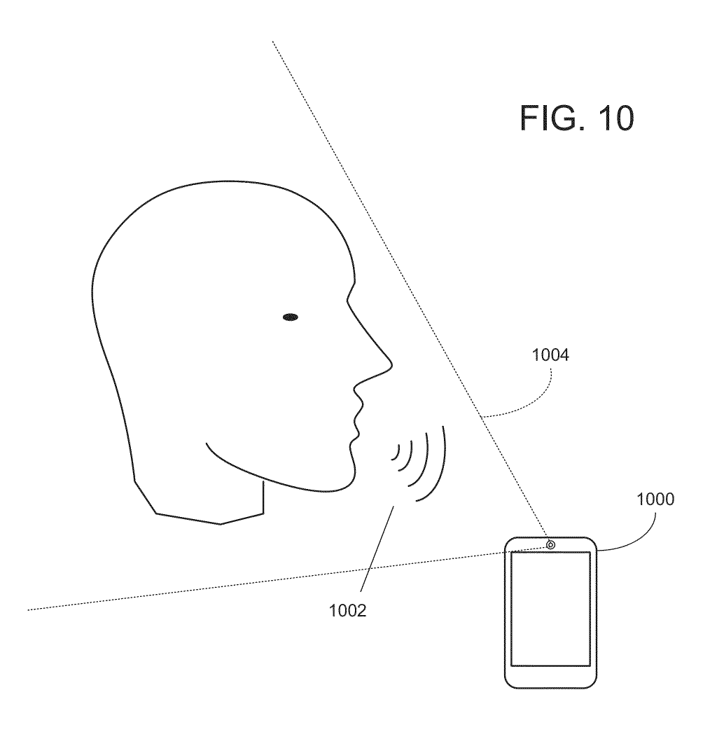

FIG. 10 depicts an example use environment for implementing method 900. A computing device 1000 in the form of a mobile device is illustrated receiving a user voice input 1002, while an image sensor on the mobile device having a field of view 1004 that encompasses the user captures image data of the user. The computing device may analyze the image data, and also the voice data, for emotional state information. As such, in this example, the voice data may be used both as an input of a content item (e.g. for conversion to text via voice recognition software), and as contextual sensor information to determine an emotional state. In such an embodiment, the single voice input may be provided to separate processing pipelines for voice recognition and emotional state detection. As another example, the image data alone may be used to detect emotional state information. It will be understood that the depicted embodiment is shown for the purpose of example, and is not intended to limiting in any manner, as the above-described methods may be implemented in any suitable computing device use environment and with any suitable type of computing device configured to receive any suitable type of digital content item input and sensor data.

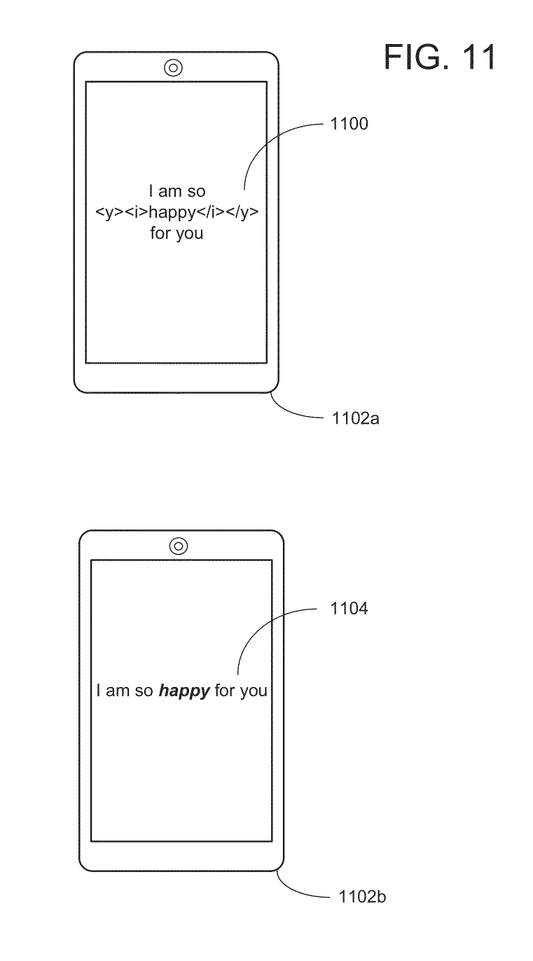

FIG. 11 depicts an embodiment of a representation of a detected emotional state associated with the user input in FIG. 10. For example, if the user of FIG. 10 inputs “I'm so happy for you,” and emphasizes the word “happy” via facial gestures and/or voice inflection, the computing device 1000 may detect this emotional state and associate the word happy (which corresponds contextually and/or temporally with the emotional state) with a representation of the detected emotional state. As depicted, the tags may be interpreted by a receiving device to display the tagged text in italics and in a color yellow (represented by the <y>, </y> tag). It will be understood that the illustrated tags are presented for the purpose of example, and that any other suitable representation of emotional state may be used.

In some embodiments, the above described methods and processes may be tied to a computing system including one or more computers. In particular, the methods and processes described herein may be implemented as a computer application, computer service, computer API, computer library, and/or other computer program product.

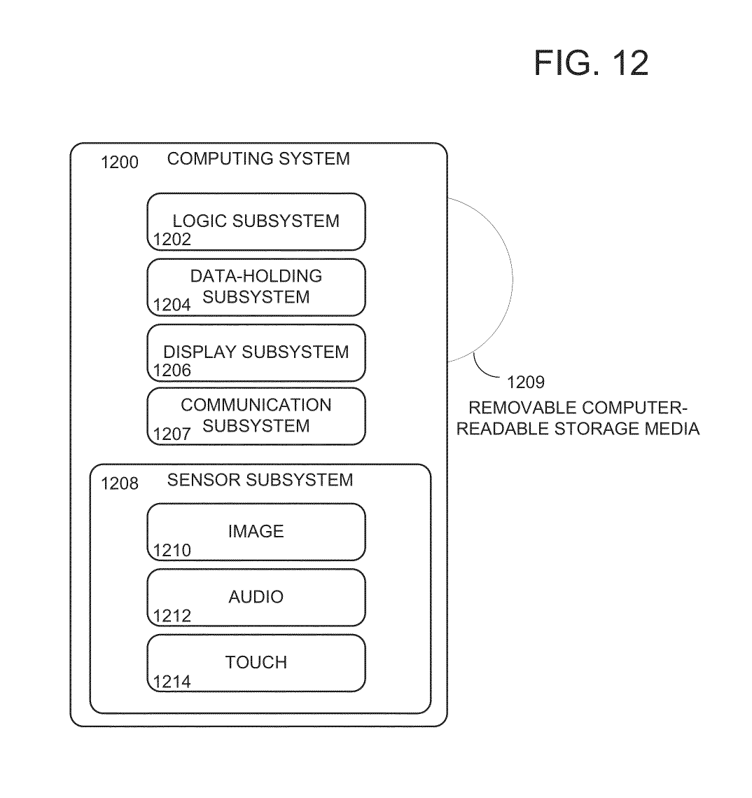

FIG. 12 schematically shows a nonlimiting computing system 1200 that may perform one or more of the above described methods and processes. Computing system 1200 is shown in simplified form. It is to be understood that virtually any computer architecture may be used without departing from the scope of this disclosure. In different embodiments, computing system 1200 may take the form of a mainframe computer, server computer, desktop computer, laptop computer, tablet computer, home entertainment computer, network computing device, mobile computing device, mobile communication device, gaming device, etc.

Computing system 1200 includes a logic subsystem 1202 and a data-holding subsystem 1204. Computing system 1200 may optionally include a display subsystem 1206 communication subsystem 1207, sensor subsystem 1208 and/or other components not shown in FIG. 12. Sensor subsystem 1208 comprises one or more image sensors 1210, such as RGB, grayscale, depth, and/or other suitable image sensors; and/or one or more audio sensors, such as one or more conventional microphones and/or a directional microphone array; and/or one or more touch sensors, such as optical, capacitive, and/or resistive touch and/or multi-touch sensors, as well as pressure sensors such as piezoelectric pressure sensors. Sensor subsystem 1208 also may comprise any other suitable type of sensor, including but not limited to one or more motion sensors. Computing system 1200 may also optionally include other input devices such as keyboards, mice, and game controllers, for example.

Logic subsystem 1202 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem 1202 may include one or more processors that are configured to execute software instructions. Additionally or alternatively, the logic subsystem 1202 may include one or more hardware or firmware logic machines configured to execute hardware or firmware instructions. Processors of the logic subsystem 1202 may be single core or multicore, and the programs executed thereon may be configured for parallel or distributed processing. The logic subsystem 1202 may optionally include individual components that are distributed throughout two or more devices, which may be remotely located and/or configured for coordinated processing. One or more aspects of the logic subsystem 1202 may be virtualized and executed by remotely accessible networked computing devices configured in a cloud computing configuration.

Data-holding subsystem 1204 includes one or more physical, non-transitory, devices configured to hold data and/or instructions executable by the logic subsystem 1202 to implement the herein described methods and processes. When such methods and processes are implemented, the state of data-holding subsystem 1204 may be transformed (e.g., to hold different data).

Data-holding subsystem 1204 may include removable media and/or built-in devices. Data-holding subsystem 1204 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 1204 may include devices with one or more of the following characteristics: volatile, nonvolatile, dynamic, static, read/write, read-only, random access, sequential access, location addressable, file addressable, and content addressable. In some embodiments, logic subsystem 1202 and data-holding subsystem 1204 may be integrated into one or more common devices, such as an application specific integrated circuit or a system on a chip.

FIG. 12 also shows an aspect of the data-holding subsystem in the form of removable computer-readable storage media 1209, which may be used to store and/or transfer data and/or instructions executable to implement the herein described methods and processes. Removable computer-readable storage media 1209 may take the form of CDs, DVDs, HD-DVDs, Blu-Ray Discs, EEPROMs, and/or floppy disks, among others.

It is to be appreciated that data-holding subsystem 1204 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of computing system 1200 that is implemented to perform one or more particular functions. In some cases, such a module, program, or engine may be instantiated via logic subsystem 1202 executing instructions held by data-holding subsystem 1204. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, display subsystem 1206 may be used to present a visual representation of data held by data-holding subsystem 1204. As the herein described methods and processes change the data held by the data-holding subsystem, and thus transform the state of the data-holding subsystem, the state of display subsystem 1206 may likewise be transformed to visually represent changes in the underlying data. Display subsystem 1206 may include one or more display devices utilizing virtually any type of technology. Such display devices may be combined with logic subsystem 1202 and/or data-holding subsystem 1204 in a shared enclosure, or such display devices may be peripheral display devices.

When included, communication subsystem 1207 may be configured to communicatively couple computing system 1200 with one or more other computing devices. Communication subsystem 1207 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing system 1200 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system, comprising:
a logic subsystem; and
a data-holding subsystem comprising instructions stored thereon that are executable by the logic subsystem to:
receive a digital content item for presentation to a user;
compare a personality type indicator of the user with one or more personality type labels associated with the digital content item; and
customize a presentation of the digital content item based on a result of comparing the personality type indicator of the user with the one or more personality type labels.

2. The computing system of claim 1, wherein the digital content item comprises one or more of an email message and a web page.

3. The computing system of claim 1, wherein the instructions are executable to customize the presentation of the digital content item by presenting a first portion of the digital content item and not presenting a second portion of the digital content item based upon comparing the personality type indicator with a personality type label associated with the first portion of the digital content item and a personality type label associated with the second portion of the digital content item.

4. The computing system of claim 1, wherein the digital content item is a first digital content item, and the instructions are further executable to:
receive a user input of a second digital content item;
receive an input associating one or more portions of the second digital content item with one or more personality type labels; and
send the second digital content item to a receiving device.

5. The computing system of claim 4, wherein the instructions are further executable to receive the input associating the one or more portions of the second digital content item with the one or more personality type labels by receiving an input selecting specified text for tagging.

6. The computing system of claim 1, wherein the instructions are further executable to receive an input of the personality type indicator of the user.

7. The computing system of claim 6, wherein the instructions are executable to receive the input of the personality type indicator of the user by presenting the user with a personality assessment.

8. The computing system of claim 1, wherein the instructions are further executable to:
receive a user input via a user input device;
detect an emotional state associated with the user input via sensor data received during receipt of the user input;
associate a representation of the emotional state with the user input; and
send the user input and the representation of the emotional state to a receiving device.

9. A computing system, comprising:
a logic subsystem; and
a data-holding subsystem comprising instructions stored thereon that are executable by the logic subsystem to:
receive a user input via a user input device;
detect an emotional state associated with the user input via sensor data received during receipt of the user input;
associate a representation of the emotional state with the user input; and
send the user input and the representation of the emotional state to a receiving device.

10. The computing system of claim 9, wherein the sensor data comprises one or more of touch data, pressure data, image data, motion data, and audio data, and wherein the emotional state is determined from one or more of a touch pressure, a gesture speed, a facial expression, a body gesture, and a voice characteristic as detected from the sensor data.

11. The computing system of claim 9, wherein the representation of the emotional state comprises a representation related to one or more of a visual presentation parameter, an audio presentation parameter, and a tactile presentation parameter.

12. The computing system of claim 11, wherein the visual presentation parameter comprises one or more of style, format, color, size, emphasis, animation, and accenting.

13. The computing system of claim 11, wherein the audio presentation parameter comprises one or more of pitch, volume, intonation, duration, prosody, rate, language and style.

14. The computing system of claim 11, wherein the tactile presentation parameter comprises vibration.

15. A method of customizing a presentation of digital content on a computing system, the method comprising:
receiving an email message for presentation to a user;
comparing a personality type indicator of the user with one or more personality type labels contained within the email message;
presenting a first portion of the email message while not presenting a second portion of the email message based upon whether the first portion of the email message and the second portion of the email message are marked with a personality type label that matches the personality type indicator of the user.

16. The method of claim 15, wherein presenting the first portion of the email message while not presenting the second portion of the email message comprises presenting only portions of the email message that are associated with the personality type label corresponding to the personality type indicator of the user.

17. The method of claim 15, wherein the email message is a first email message, and further comprising:
receiving an input of a second email message;
receiving an input tagging one or more portions of the second email message with one or more personality type labels; and
sending the second email message to a receiving device.

18. The method of claim 17, wherein receiving the input tagging the one or more portions of the email message with the one or more personality type labels comprises receiving an input selecting specified text for tagging.

19. The method of claim 17, wherein receiving the input tagging the one or more portions of the email message with the one or more personality type labels comprises receiving an input selecting a predefined section of a template.

20. The method of claim 15, wherein the personality type labels are color-based.
